(19) United States
(12) Patent Application Publication
(10) Pub. No.: US 2024/0355106 A1
(43) Pub. Date: Oct. 24, 2024

(54) METHOD AND DEVICE FOR TRAINING SEGMENTATION MODEL

(71) Applicant: Quanta Computer Inc., Taoyuan City (TW)

(72) Inventors: Chia-Yuan CHANG, Taoyuan City (TW); Kai-Ju CHENG, Taoyuan City (TW); Shao-Ang CHEN, Taoyuan City (TW); Kuan-Chung CHEN, Taoyuan City (TW)

(21) Appl. No.: 18/519,676

(22) Filed: Nov. 27, 2023

(30) Foreign Application Priority Data
Apr. 18, 2023 (TW) 112114332

(51) Int. Cl. G06V 10/82; G06V 20/70

(52) U.S. Cl. CPC G06V 10/82; G06V 20/70

(57) ABSTRACT

A method for training a segmentation model is provided. The method includes using first training images to train a segmentation model. The method includes using second training images to train an image generator. The method includes inputting real images into the segmentation model to generate predicted annotation images. The method includes inputting the predicted annotation images into the image generator to generate fake images. The method includes updating the segmentation model and the image generator according to a loss caused by differences between the real images and the fake images.

### CROSS REFERENCE TO RELATED APPLICATIONS

This application claims priority from Taiwan Patent Application No. 112114332, filed on Apr. 18, 2023, the disclosure of which is incorporated herein in its entirety by reference.

### BACKGROUND OF THE APPLICATION

### Field of the Application

The present disclosure generally relates to a method and a device for training a segmentation model. More specifically, aspects of the present disclosure relate to a method and a device for training a segmentation model using an image generator.

### Description of the Related Art

Image segmentation is a crucial technology in the field of image processing technology, because it is a preliminary step in image processing, and the quality of segmentation directly affects the results of subsequent processing, such as feature extraction and target recognition.

Currently, the images used to train segmentation model parameters use labeled images. Labeled images may be defined as a set of values for the features for which the classification result is known. The classification result is usually referred to as a label. Unlabeled images may be defined as a set of values for the features for which the classification result is not known.

However, labeled data are often difficult and expensive to obtain. Moreover, labeled data are usually required in large quantities to yield an accurate segmentation model which renders the task of acquiring labeled images even more daunting.

Therefore, there is a need for a method and a device for training a segmentation model to achieve the purpose of using a combination of labeled images and unlabeled images to generate a more accurate segmentation model.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method and a device for training a segmentation model.

In an exemplary embodiment, a method for training a segmentation model is provided. The method includes using first training images to train a segmentation model. The method includes using second training images to train an image generator. The method includes inputting real images into the segmentation model to generate predicted annotation images. The method includes inputting the predicted annotation images into the image generator to generate fake images. The method includes updating the segmentation model and the image generator according to a loss caused by differences between the real images and the fake images.

In some embodiments, the first training images are labeled images.

In some embodiments, the second training images are labeled images.

In some embodiments, the real images comprise labeled images and unlabeled images.

In some embodiments, the segmentation model is based on a Visual Geometry Group (VGG) U-net model.

In some embodiments, the image generator is based on a Generative Adversarial Network (GAN) model with pixel to pixel correspondence.

In an exemplary embodiment, a device for training a segmentation model is provided. The device comprises one or more processors and one or more computer storage media for storing one or more computer-readable instructions. The processor is configured to drive the computer storage media to execute the following tasks. The following tasks comprise using first training images to train a segmentation model. The following tasks comprise using second training images to train an image generator. The following tasks comprise inputting real images into the segmentation model to generate predicted annotation images. The following tasks comprise inputting the predicted annotation images into the image generator to generate fake images. The following tasks comprise updating the segmentation model and the image generator according to a loss caused by differences between the real images and the fake images.

### BRIEF DESCRIPTION OF DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram illustrating a system for training a segmentation model according to an embodiment of the present disclosure.

FIG. 2 is a flowchart illustrating a method for training a segmentation model according to an embodiment of the present disclosure.

FIG. 3 is a schematic diagram illustrating a method for training a segmentation model according to an embodiment of the present disclosure.

FIGS. 4A to 4C are schematic diagrams illustrating the real images, the predicted annotation images and the fake images according to an embodiment of the present disclosure.

FIG. 5 is a schematic diagram illustrating the accuracy between the fake images generated by the segmentation model and the image generator and the real images according to an embodiment of the present disclosure.

FIG. 6 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

The embodiments of the present disclosure provide a method and a device for training a segmentation model, using an image generator to train the segmentation model, so that the segmentation model can be trained using labeled images and unlabeled images.

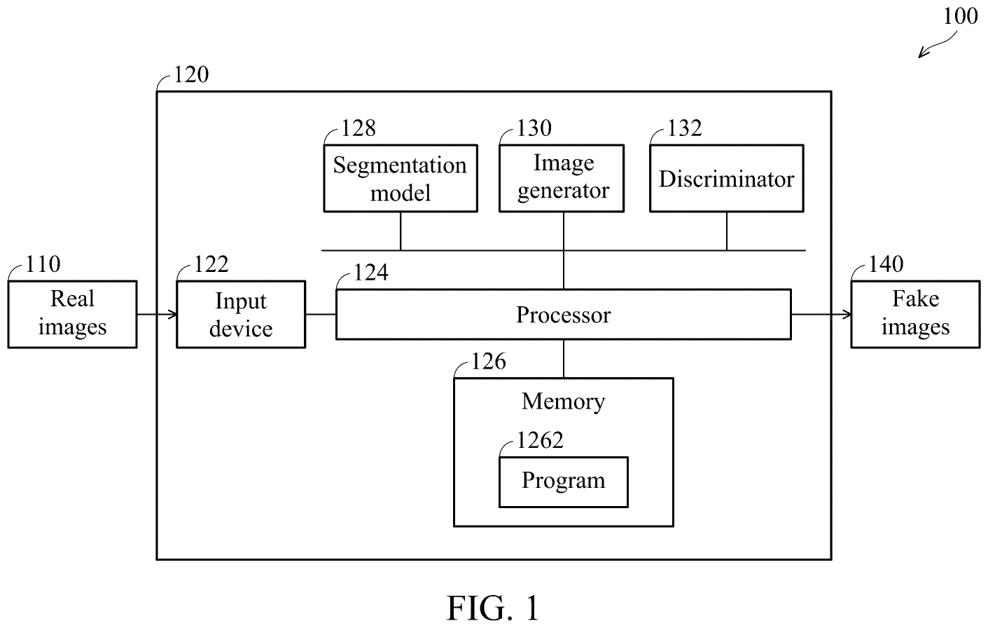

FIG. 1 is a schematic diagram illustrating a system 100 for training a segmentation model according to an embodiment of the present disclosure. A device 120 in system 100 can receive real images 110 and generate fake images 140 that resemble the real images 110.

The device 120 may comprise an input device 122, wherein input device 122 is configured to receive input data (e.g., the real images 110) from various sources. For example, the device 120 may receive the real images 110 as labeled images or unlabeled images from a network or a cloud server.

The device 120 also includes a processor 124, a segmentation model 128, an image generator 130, a discriminator 132 and a memory 126 that can store a program 1262. Additionally, images may be stored in the memory 126 or in the segmentation model 128. The segmentation model 128 uses a neural network to generate predicted annotation images. The image generator 130 receives the predicted annotation images and generates fake images. The discriminator 132 is used to identify the difference between the real images 110 and the fake images 140. In one embodiment, the segmentation model 128 is based on a convolutional neural network (CNN) model, for example, a Visual Geometry Group (VGG) U-net model, and the image generator is based on a Generative Adversarial Network (GAN) model with pixel to pixel correspondence.

In addition, the device 120 may also have a large database for storing different labeled images and unlabeled images. The device 120 may obtain different labeled and unlabeled images to train the segmentation model 128 and the image generator 130.

In one embodiment, the segmentation model 128, the image generator 130 and the discriminator 132 may be implemented by the processor 124. In another embodiment, the device 120 may be used with other components, systems, subsystems and/or devices other than those described herein.

Types of the device 120 range from small handheld devices (e.g., mobile phones/portable computers) to large host systems (e.g., mainframe computers). Examples of portable computers include personal digital assistants (PDAs), notebook computers, and other devices.

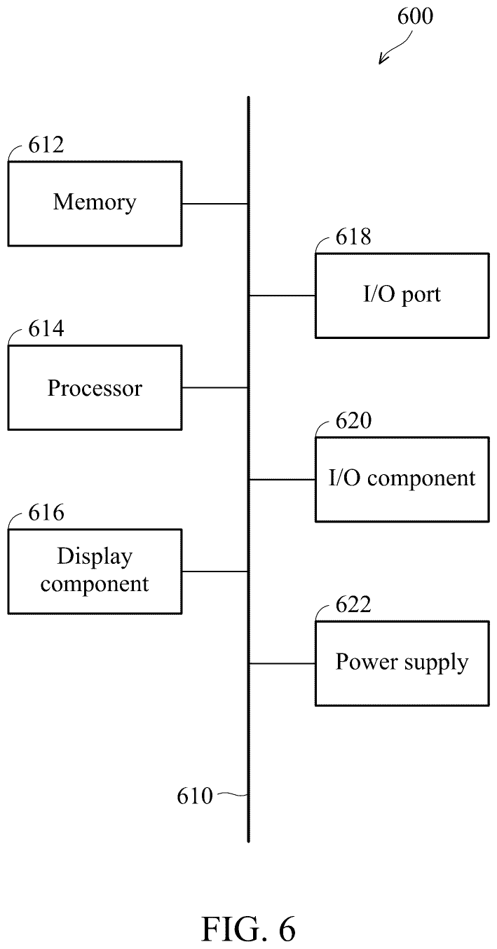

It should be understood that the device 120 shown in FIG. 1 is an example of the architecture of the system 100 for training a segmentation model. Each element shown in FIG. 1 can be implemented via any type of computing device, such as the computing device 600 described with reference to FIG. 6, as shown in FIG. 6.

It should be noted that, as used herein, the term “training” is used to identify the objects used to train the segmentation model and the image generator. Therefore, training images are the images used to train the segmentation model and the image generator.

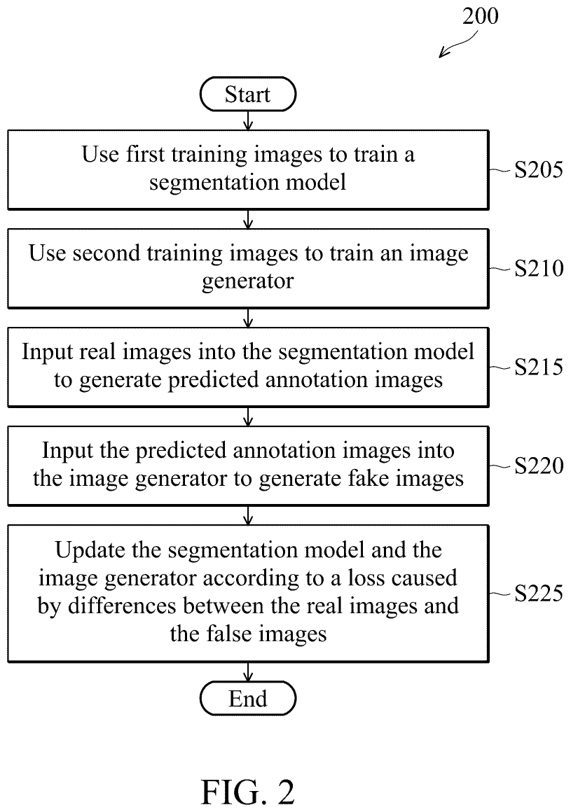

FIG. 2 is a flowchart illustrating a method 200 for training a segmentation model according to an embodiment of the present disclosure. This method can be implemented by the processor 124 of the device 120 in FIG. 1.

In step S205, the device uses first training images to train a segmentation model, wherein the first training images are labeled images, for example, real images used for training. In one embodiment, the segmentation model is based on a convolutional neural network (CNN) model, for example, a VGG-U-net model.

Then, in step S210, the device uses second training images to train an image generator, wherein the second training images are labeled images, for example, annotation images used for training. In one embodiment, the second training images are different from the first training images.

In step S215, the device inputs real images into the segmentation model to generate predicted annotation images, wherein the real images comprise labeled images and unlabeled images.

Next, in step S220, the device inputs the predicted annotation images into the image generator to generate fake images.

In step S225, the device updates the segmentation model and the image generator according to a loss caused by the differences between the real images and the false images. Specifically, the device adjusts the parameters in the segmentation model and the image generator based on the loss caused by differences between the real images and the false images to help train the segmentation model and the image generator.

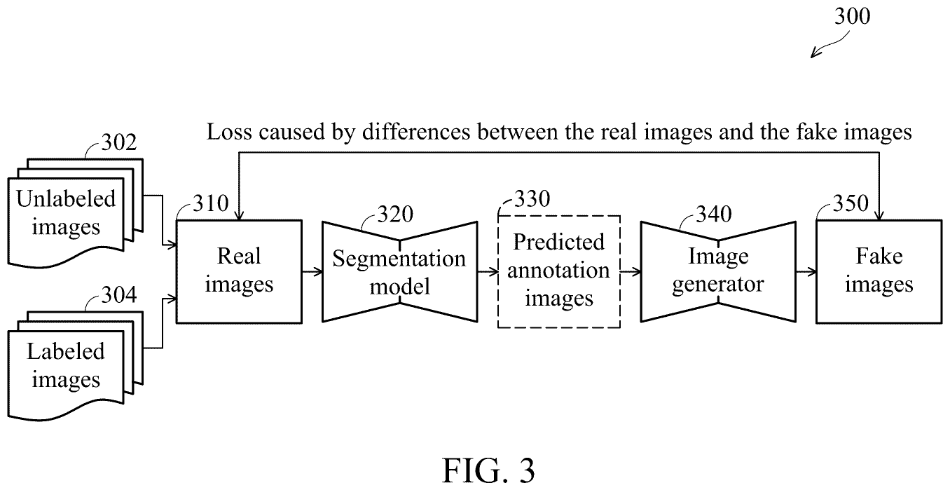

For example, FIG. 3 is a schematic diagram 300 illustrating a method for training a segmentation model according to an embodiment of the present disclosure to illustrate steps S215˜S225 in FIG. 2.

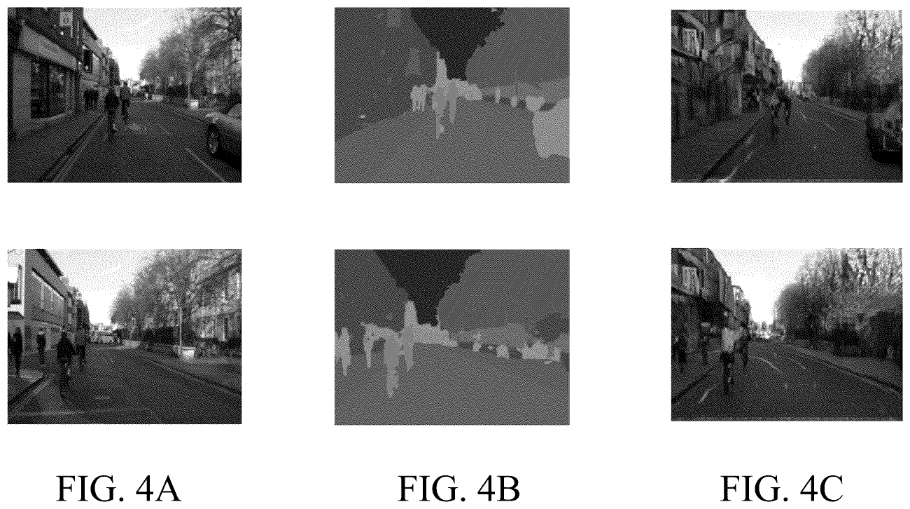

Before starting the process of the schematic diagram 300, the device has first trained the segmentation model 320 and the image generator 340. The device inputs the real images 310 including the unlabeled images 302 and the labeled images 304 into the segmentation model 320, wherein the real images 310 are shown in FIG. 4A.

Next, the segmentation model 320 generates the predicted annotation images 330 and inputs the predicted annotation images 330 into the image generator 340. The predicted annotation images 330 are shown in FIG. 4B.

The image generator 340 generates and outputs the fake images 350 after receiving the predicted annotation images 330, as shown in FIG. 4C. The device may update and train the segmentation model 320 and the image generator 340 based on the loss caused by the differences between the real images 310 and the fake images 350.

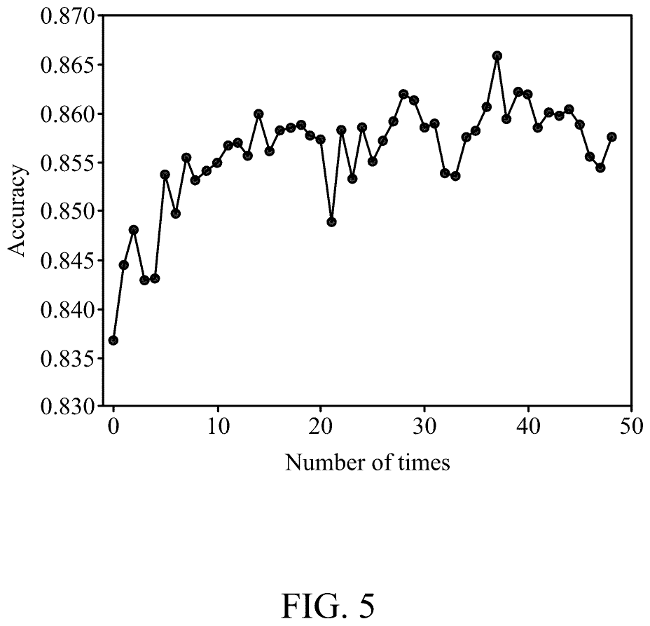

FIG. 5 is a schematic diagram illustrating the accuracy of the segmentation model according to an embodiment of the present disclosure, wherein the segmentation model is a segmentation model trained using the method 200 in FIG. 2. In FIG. 5, the vertical axis is accuracy, and the horizontal axis is the number of times of training the segmentation model. As shown in FIG. 5, the accuracy of the segmentation model has improved significantly after multiple trainings. The accuracy of the segmentation model that has not been trained (the number of times of training is 0) gradually increases from 0.835 to 0.865 after training.

As mentioned above, a method and a device for training a segmentation model provided in the present disclosure attach an image generator to the segmentation model, and the labeled images and the unlabeled images are used to train the segmentation model and the image generator, so that the segmentation model has better performance. In addition, the unlabeled images can be used for training in the present disclosure, which not only saves the cost of labeling images, but also saves a lot of time in collecting labeled images and training models.

Having described embodiments of the present disclosure, an exemplary operating environment in which embodiments of the present disclosure may be implemented is described below. Referring to FIG. 6, an exemplary operating environment for implementing embodiments of the present disclosure is shown and generally known as a computing device 600. The computing device 600 is merely an example of a suitable computing environment and is not intended to limit the scope of use or functionality of the disclosure. Neither should the computing device 600 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 6, the computing device 600 may include a bus 610 that is directly or indirectly coupled to the following devices: one or more memories 612, one or more processors 614, one or more display components 616, one or more input/output (I/O) ports 618, one or more input/output components 620, and an illustrative power supply 622. The bus 610 may represent one or more kinds of busses (such as an address bus, data bus, or any combination thereof). Although the various blocks of FIG. 6 are shown with lines for the sake of clarity, and in reality, the boundaries of the various components are not specific. For example, the display component such as a display device may be considered an I/O component and the processor may include a memory.

The computing device 600 typically includes a variety of computer-readable media. The computer-readable media can be any available media that can be accessed by computing device 600 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the computing device 600. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 612 may include computer-storage media in the form of volatile and/or nonvolatile memory. The memory may be removable, non-removable, or a combination thereof. Exemplary hardware devices include solid-state memory, hard drives, optical-disc drives, etc. The computing device 600 includes one or more processors that read data from various entities such as the memory 612 or the I/O components 620. The display component(s) 616 present data indications to a user or to another device. Exemplary presentation components include a display device, speaker, printing component, vibrating component, etc.

The I/O ports 618 allow the computing device 600 to be logically coupled to other devices including the I/O components 620, some of which may be embedded. Illustrative components include a microphone, joystick, game pad, satellite dish, scanner, printer, wireless device, etc. The I/O components 620 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the computing device 600, or any combination thereof. The computing device 600 may be equipped with depth cameras, such as stereoscopic camera systems, infrared camera systems, RGB camera systems, or any combination thereof, to realize gesture detection and recognition. Furthermore, the computing device 600 may be equipped with accelerometers or gyroscopes that enable detection of motion. The output of the accelerometers or gyroscopes may be provided to the display of the computing device 600 to carry out immersive augmented reality or virtual reality.

Furthermore, the processor 614 in the computing device 600 can execute the program code in the memory 612 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for training a segmentation model, comprising:
using first training images to train a segmentation model;
using second training images to train an image generator;
inputting real images into the segmentation model to generate predicted annotation images;
inputting the predicted annotation images into the image generator to generate fake images; and
updating the segmentation model and the image generator according to a loss caused by differences between the real images and the fake images.

2. The method for training a segmentation model as claimed in claim 1, wherein the first training images are labeled images.

3. The method for training a segmentation model as claimed in claim 1, wherein the second training images are labeled images.

4. The method for training a segmentation model as claimed in claim 1, wherein the real images comprise labeled images and unlabeled images.

5. The method for training a segmentation model as claimed in claim 1, wherein the segmentation model is based on a Visual Geometry Group (VGG) U-net model.

6. The method for training a segmentation model as claimed in claim 1, wherein the image generator is based on a Generative Adversarial Network (GAN) model with pixel to pixel correspondence.

7. A device for training a segmentation model, comprising:
one or more processors; and
one or more computer storage media for storing one or more computer-readable instructions, wherein the processor is configured to drive the computer storage media to execute the following tasks:
using first training images to train a segmentation model;
using second training images to train an image generator;
inputting real images into the segmentation model to generate predicted annotation images;
inputting the predicted annotation images into the image generator to generate fake images; and
updating the segmentation model and the image generator according to a loss caused by differences between the real images and the fake images.

8. The device for training a segmentation model as claimed in claim 7, wherein the first training images are labeled images.

9. The device for training a segmentation model as claimed in claim 7, wherein the second training images are labeled images.

10. The device for training a segmentation model as claimed in claim 7, wherein the real images comprise labeled images and unlabeled images.
